(19) United States
(12) Patent Application Publication
(10) Pub. No.: US 2023/0261545 A1
(43) Pub. Date: Aug. 17, 2023

(54) SOLAR PULSE GENERATOR/RECHARGER FOR ELECTRIC VEHICLES

(71) Applicant: Michael Curtis Grayson, Bolivar, TN (US)

(72) Inventor: Michael Curtis Grayson, Bolivar, TN (US)

(21) Appl. No.: 17/968,588

(22) Filed: Oct. 18, 2022

Related U.S. Application Data
(63) Continuation-in-part of application No. 17/590,779, filed on Feb. 1, 2022.
Application No. 17/590,779 is a continuation of application No. 16/801,505, filed on Feb. 26, 2020, now abandoned.
(60) Provisional application No. 63/256,752, filed on Oct. 18, 2021.

(51) Int. Cl. H02K 7/18; B60L 53/50; H02J 7/00; B60L 53/60; H02K 11/00; B60L 50/90

(52) U.S. Cl. CPC H02K 7/1846; B60L 50/90; B60L 53/50; B60L 53/60; H02J 7/007; H02K 11/0094

(57) ABSTRACT

A retractable solar cell/panel - based pulse motor generator of a range extender and recharger for electric vehicles, buildings, equipment and devices (“vehicles”). The retractable solar cell/panel-based pulse motor generator includes retractable solar panel(s), a smart ultracapacitor, a smart charge controller, a smart power strip, a pulse motor generator, and a pancake-shaped generator device. The retractable solar cell/panel-based pulse motor generator is a kind of installed solar power recharger, sunscreen and or window tinting-based pulse generator motor range extender and recharger for electric vehicles, which can be configured to dramatically increase the vehicle’s driving range and/or the use of equipment and devices before recharging is necessary, and greatly reduces or eliminates the need for fossil fuel-based electricity or electric grids for buildings and equipment.

### CROSS-REFERENCE TO RELATED APPLICATION

This application claims the benefit of U.S. Provisional Pat. Application Serial No. 63/256,752, filed Oct. 18, 2021, the entire contents and disclosure of which are hereby incorporated herein by reference. This application is a continuation-in-part of U.S. Pat. Application Serial No. 17/590,779 filed Feb. 1, 2022, which is a continuation of U.S. Pat. Application Serial No. 16/801,505 filed Feb. 26, 2020. The entire contents and disclosures of U.S. Pat. Application Serial No. 17/590,779 and U.S. Pat. Application Serial No. 16/801,505 are incorporated by reference as if fully set forth herein.

### FIELD OF INVENTION

The present invention relates to electric vehicles (such as electric cars) generally, and more particularly, to a portable retractable attachable/detachable solar power recharger sunscreen and or window tinting-based range extender and recharger for electric vehicles configured to dramatically increase the vehicle’s driving range and greatly reduce or eliminate the need for recharging, or use of the electric grid.

### BACKGROUND

Although pure electric vehicles have the advantage of energy-savings, environmental protection, and zero discharge, the continual mileage range is currently very limited. In order to achieve mass application and acceptance of the electric vehicle, the range must meet or exceed that of conventional fossil fuel powered vehicles. Currently 400 miles is the average range for a fossil fuel vehicle. This range has become standard and is very consumer friendly because of the fact that there is a wide choice of gas stations available and refueling takes only five minutes. It would be very easy to give gas cars a higher range, just put in a bigger tank. For electric vehicles the solution is not as simple. The average range of an electric vehicle is currently 150 miles. Adding more battery as the solution for perceived range needs only adds more cost to the profitability-challenged electrified vehicle. Vehicle Costs Already Too High for Mainstream Customers and given the inherent cost disadvantages faced by EV’s vs. conventional vehicles and less financial policy support in the future, even the current $50 per additional mile of cost to the vehicle is quite impractical, given the number/frequency of trips that truly require most of the battery range. Larger batteries will also incur larger warranty expenses for the OEM as well as greater freight and recycling costs.

More Mass on the Vehicle. Batteries are very heavy. Compensating with Lightweight Materials is Expensive. In order to meet very stringent fuel economy & CO2 targets globally (primarily China, Europe, US & CA), all vehicles will have to be lighter and more mass efficient. Automotive OEM’s will pay more in premium materials for weight savings. Adding 4 lbs. of battery mass is roughly equal to 1 mile of EV range. Longer Charging Times to Top-off. Charging Infrastructure for Long Distance Trips under currently under development however no solution is close at hand.

Key Customers today are very accustomed to short re-fueling times at gas stations. Charging an EV is a much different experience and has been a challenge since the days of Edison’s efforts to supply the first batteries for electric cars. The larger the batteries become, the more and faster charging solutions that are required and continuous high-power charging can increase battery degradation.

Less Packaging Space for other Components. More stuff on vehicles with high tech features and autonomous driving leaves less room for batteries and not more. As batteries become larger to provide more range, given a fixed vehicle size, packaging of components and new features become an acute challenge for all of the elements requiring space within the vehicle architecture including passenger and cargo carrying expectations. Future self-driving systems will further accentuate this issue as well as require more energy consumption.

More Structural Requirements for Crashworthiness. Must Protect the Bigger Batteries. We are often reminded that both gas tanks and batteries contain so much energy and they need to be carefully protected from thermal events that can occur during crashes. Larger batteries are greater engineering challenges requiring more substantive structures/systems.

More Robust Support Systems Required Mass Begets Mass As the battery grows and the mass of the vehicle increases, other components from brakes, suspension, thermal management, etc. must be designed and reinforced to handle these challenges; the result is even more mass and cost added to the vehicle.

Without solutions to all these problems the electric vehicle just cannot advance.

### SUMMARY

Aspects of the present invention relate to addressing each of these problems in a practical, reliable and cost-effective way. There is provided a wheel based permanent magnet generator having the advantage of high efficiency, high power density, and has more wide application prospect.

In an aspect, the current invention is directed to an installed solar power recharger sunscreen and or window tinting-based range extender (RE) and recharger for electric vehicles dramatically increasing the vehicles driving range and greatly reducing or eliminating the need for recharging, or using the electric grid. This device has a low weight and reduces the need for large battery packs and therefore effectively lowering the sprung weight of the vehicle and speeding recharge times.

In one aspect, there is provided a solar panel-based generator of a range extender and recharger for an electric vehicle is characterizedby comprising a solar panel which convers solar energy into electricity, then uses that electricity to power a pulse motor which powers a pancake generator. This is a high efficiency, brushless generator design that utilizes the solar energy from solar panels, together with the mechanical energy of the pulse motor to create a brushless generator that will deliver power to the engine directly or can be diverted to the battery bank for recharging. This device can be configured several ways. The primary way to configure this device is denoted in this application as Device 1. In the case of Device 1 the pulse generator is arranged such that this pulsed motor uses short pulses of current to drive the motor, making it spin which is powered by the solar panels. The spinning rotor of the pulse motor is heavy, acting as a flywheel, and has multiple permanent magnets spaced equally around its periphery. These magnets are usually extremely strong and can be arranged in a variety of different configurations. In device 1 all the magnets facing radially outward.

The stator is the stationary part of the motor that surrounds the rotor. It holds one or more electrical coils. They are positioned so that the magnets line up with the coils during part of the rotation. The coils are energized when they are exactly lined up with the permanent magnets in the rotor. This requires very precise timing, usually achieved through some type of electronic control circuit.

The electrical coils are normally wound so that, when energized with a short pulse of current, they produce a repulsive force. This repulses the magnet in the rotor, causing it to rotate. Controller power circuits that produce the rotational torque by delivering pulses to the electrical coils at a precise moment during the rotation of the motor.

The pulse motor is attached to a pancake-shaped generator. This assembly constitutes the stator body housing and has electrodes made of soft iron. This armature winding is completely concealed by the housing in the shape of a pancake. This dense magnet wiring cluster forms the firstmajor segment of the Device 1 generator. There are several layers of wire in this cluster. The armature coil is stationary. The magnetic field is created through electric current in the wire-wound coil and strengthened by a soft-iron core. The armature coil assembly converts the mechanical energy of the rotating pulse motor into electrical energy by passing the permanent magnet in the housing rotors through this armature winding. The generator housing, which houses the permanent magnets on the rotor wheel. The wheel thus becomes the rotor. The Rotor produces rotating magnetic flux or rotating magnetic field associated with the rotor inducing electricity in the armature coil attached to the housing. The electricity produced is then diverted to the charge controller. The charge controller now powers the engine directly or recharges the battery based on the currentneeds of the vehicle. Permanent magnetics are arranged at intervals around a center wheel hub. Each permanent magnet is attached in sequence to the center hub. Each magnet is adhered to the center hub alternating the north and south pole orientation of each magnet. They are arranged in a pattern of four or more and adhered to the wheel to form the device.

The range extender can be used to power automobiles where the solar panels are placed on the roof of the vehicle or in the windows. The power produced by these devices will be sufficient to power the frictionless low torque high speed pulse motor. The super high speeds of the pulse motor can now be used to power the rotor of the pancake generator and create high voltage. This device can also be used to power buildings and homes by using solar panels or wind turbines and diverting this energy to the ultracapacitor storage device which will be used to power the pulse motor. Placed in a side car-based system or mounted in a building this high speed portable charging system which is essentially a mobile commercial generator that uses the same principle of converting the mechanical energy of the pulse generator into electricity. The idea is that this charge on the go system will negate the need for lengthy charging stops for vehicles and allow buildings to become truly green.

### BRIEF DESCRIPTION OF THE DRAWINGS

FIG. 1 depicts a translucent solar panel that can be attached to a vehicle window as a tinting sunscreen for a vehicle range extender and recharger according to an embodiment of the present invention.

FIG. 2 depicts a vehicle having a translucent solar panel installed at a top window or roof of an electric vehicle that can function as a vehicle range extender and recharger in an embodiment.

FIG. 3 depicts a vehicle including a solar panel attached to a roof of the vehicle and the electronics within the vehicle for processing the converted energy from the solar panel according to an embodiment.

FIG. 4 depicts a collapsible mechanism for interior panels which is an alternate embodiment of an attached window tinting sunscreen solar panel for a vehicle range extender and recharger in an embodiment.

FIG. 5 conceptually depicts an ultracapacitor that can be used in conjunction with the energy system processing for attached window tinting sunscreen solar panel for a vehicle range extender and recharger in embodiments herein;

FIG. 6 depicts a pulse generator that receives power from the solar panels that is stored at an ultracapacitor in an embodiment.

FIG. 7 depicts a generator device is a pancake shaped device that is responsive to pulses from the pulse generator to create charge;

FIG. 8 depicts a smart power strip which collects the power generated from all of the solar panels for subsequent diversion to the ultracapacitor for storage in an embodiment; and

FIG. 9 is a block diagram of a charge computer for use in window tinting sunscreen solar panel vehicle range extender and recharger of an embodiment;

### DETAILED DESCRIPTION

The present invention relates to an installed solar power recharger sunscreen and or window tinting-based range extender and recharger for electric vehicles dramatically increasing the vehicles driving range and greatly reducing or eliminating the need for recharging, or using the electric grid, this device is called the Grayson Range Extender 7.0 (GRE), belong to electrics technical field. This device has a low weight and reduces the need for large battery packs and therefore effectively lowering the sprung weight of the vehicle and speeding recharge times.

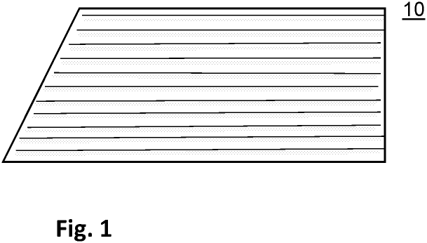

FIG. 1 depicts a translucent solar panel that is attached as a window tinting sunscreen for a vehicle range extender and recharger according to an embodiment of the present invention., the Grayson Range Extender 7.0 (GRE). Wherein the translucent/solar panels is first directed to a smart power strip for collection then it is directed to a smart ultracapacitor where it is stored prior to being used to power the solar pulse generator motor. The power from the solar pulse generator is directed to the smart charge controller where it can used to power a vehicle/building or is stored. Afterwards that energy is directed to a micro grid where it can be used to power the vehicle/building, stored for later use in a battery storage device or returned to the grid.

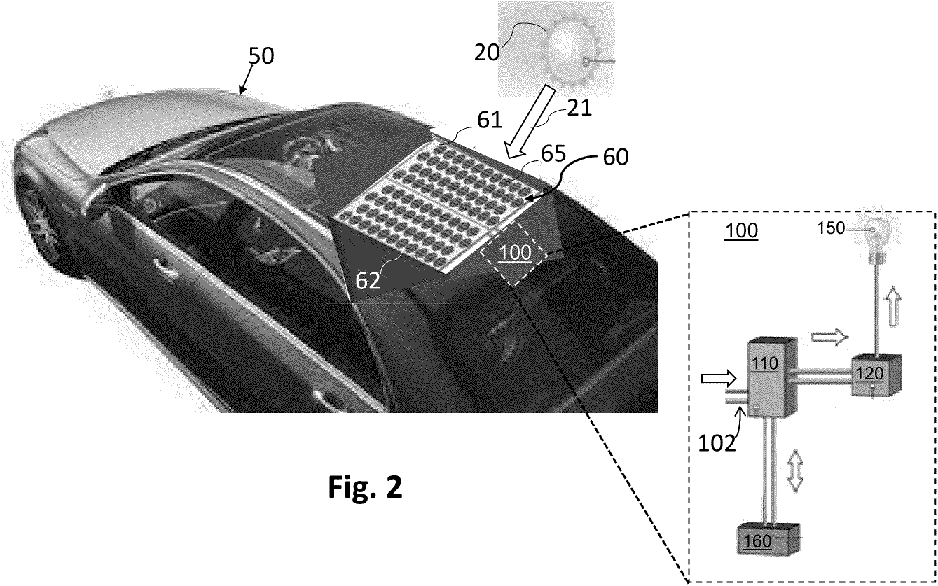

FIG. 2 depicts a portion of an electric vehicle 50 having a translucent solar panel 60 installed as a top window (e.g., sunroof/moonroof) that can function as a vehicle range extender and recharger in an embodiment. In other embodiments, the translucent/ solar panels 60 can be attached to the electric vehicle in various locations, as side windows and can serve as window tinting. As shown in FIG. 2, the translucent solar panel 60 includes two photovoltaic modules 61, 62 each module having a plurality of photovoltaic cells 65 that function to convert sunlight 21 from the sun 20 into energy. Sunlight 21 provides as much as 1000 Watts per square meter of energy to the Earth’s surface. As further shown in FIG. 2, included at the vehicle 50 is an energy conversion unit 100 that receives the energy generated by the photovoltaic cells of panel modules 61, 62 via conductive lines 102. The generated energy can be a direct current (DC) and this is transmitted to a pulse generator motor 110 for generating electrical pulses that can be used to charge a large energy storage device 120 such as a battery or capacitor. Once stored in a battery or capacitor, this energy can be conveyed along conductive lines for powering energy devices 150. Further, as there can be excess energy produced, this energy can be distributed such as for storage in a storage device, e.g., an ultracapacitor 160, for future use or for subsequent sale to electrical utilities.

In an embodiment, the power generated by solar panels 60 can be diverted to an ultracapacitor then used to power the solar pulse generator, and then diverted to a microgrid.

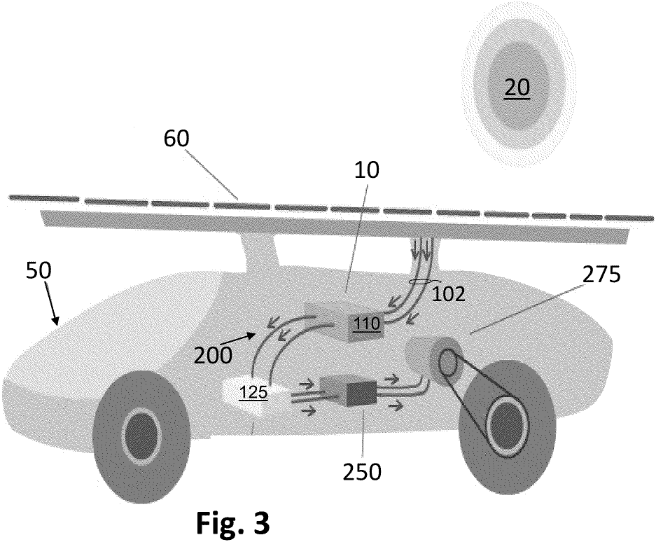

FIG. 3 depicts a vehicle 50 including a translucent solar panel 60 attached to a roof of the vehicle and the electronic system 200 within the vehicle for processing the converted energy from the solar panel for use as a vehicle range extender and recharger in an embodiment. The translucent solar panels can be attached to the electric vehicle in various locations, on side windows, rear windows, etc.. For example, the translucent panels 60 can serve as window tinting, e.g., for a sunroof. The DC current 105 generated by the solar panel 60 is diverted over conductors 102 for receipt at an ultracapacitor (not shown) and then further conveyed to power a pulse motor generator 110, Power pulses 205 are converted to a large energy storage device 120 such as a battery pack 125. This stored energy can be used to power a smart motor controller device 250 which uses the power or sends to a vehicle motor 275.

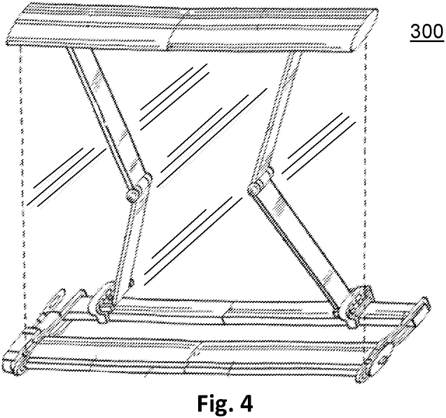

FIG. 4 depicts a collapsible sunscreen device 300 for interior panels which is an alternate embodiment of an attached window tinting sunscreen solar panel for a vehicle range extender and recharger in an embodiment. The collapsible mechanism 300 includes the solar panels and can be attached to the electric vehicle in various locations. The translucent panels can serve as window tinting and can be attached directly to the window or mounted in an electric sunscreen device.

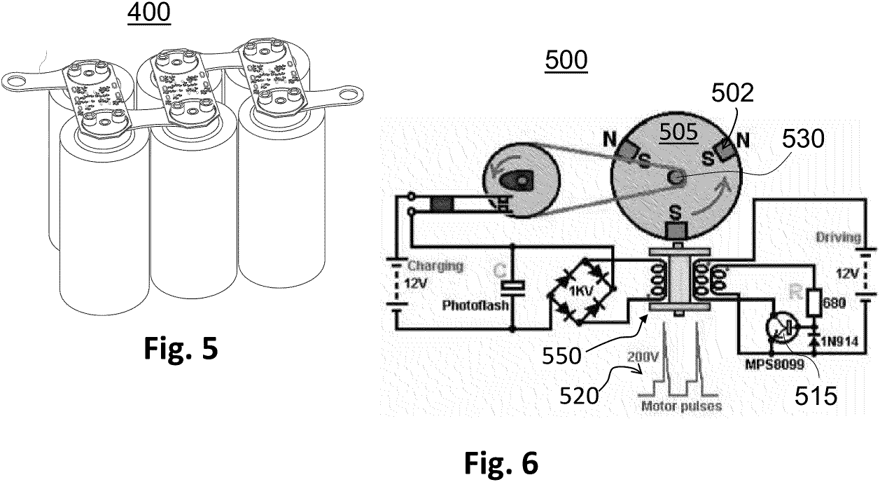

FIG. 5 conceptually depicts an ultracapacitor 400 that can be used in conjunction with the solar energy system processing for attached window tinting sunscreen solar panels for a vehicle range extender and recharger in embodiments herein. In the system processing embodiments described herein, the DC current (power) generated by the solar panels is directed to an ultracapacitor for storage thereat.

As described in commonly-owned U.S. Pat. Application Serial No. 17/590,779, incorporated by reference herein, the high capacity Ultracapacitor Flash Storage Device 400 of FIG. 5 is a computer-controlled device for storing electrical energy and is constructed in such a way as to allow for fast charging, fast transfer of charge, high voltage, and the storage of large volumes of charge produced by the pulse generator devices.

Ultracapacitor Flash Storage Device 400 can be used to replace a battery pack and can relegate the battery pack to a function of simply starting a vehicle. The device creates so much charge that it cannot simply dump that charge into a battery pack. The charge must first be diverted to the UFSD. Battery packs resist fast charging and high-density charge. That is why EVS have so many fires and heat- based problems.

The UFSD 400 serves as a smart buffer that can trickle charge the battery when necessary but more importantly it can power the vehicle directly. In addition, at the end of the day the power stored in the UFSD can be diverted to the grid, other accessories, or a personal mini grid. The next day the battery pack starts the car, then the GRE charges the UFSD so that the UFSD can power the car once it has reached sufficient charge.

FIG. 6 depicts a pulse generator circuit 500 that receives power from the solar panels that is stored at an ultracapacitor in an embodiment. In an embodiment, the solar pulsed motor uses short pulses of current from the solar panels to drive the motor. The part of the motor that spins is called the rotor. Typically, it is quite heavy, acting as a flywheel (disc) 505, and has multiple permanent magnets 502 spaced equally around its periphery. These magnets are usually extremely strong and can be arranged in a variety of different configurations. The stator (not shown) is the stationary part of the motor that surrounds the rotor. It holds one or more electrical coils 550. They are positioned so that the magnets line up with the coils during part of the rotation. The coils 550 are energized when they are exactly lined up with the permanent magnets in the rotor. This is achieved through an electronic control circuit. The electrical coils are wound so that, when energized with a short pulse of current, they produce a repulsive force. This repulses the magnet in the rotor, causing it to rotate. After being energized by a short pulse, the magnetic field formed around the electrical coil then collapses.

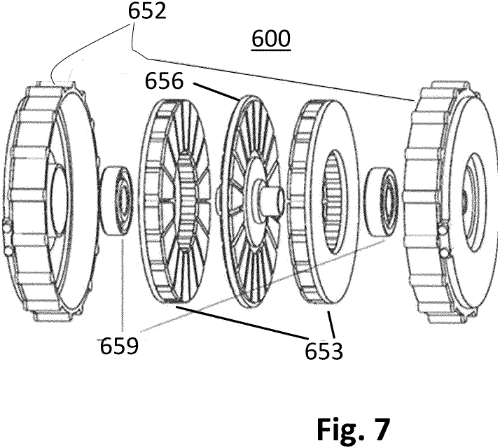

The pulse generator 500 sacrifices torque for speed. The torque motor reaches very high rpms. That is, typically, a car tire rotates at less than 2000 rpm, whereas the pulse motor can rotate at 20,000 rpm. As the pulse motor reaches a maximum rpm it is connected to the pancake generator (FIG. 7) which converts the higher rpm into an electric charge. While charge can be created, whenever the car slows down or is off, the battery stops charging. If power of the vehicle range extender components charge a capacitor, then even when the car is idle or stopped it will continue to power the pulse generator until the capacitor is empty. One difference between the pancake generator (FIG. 7) and the pulse motor is that the pulse motor has the magnets 502 on the side of the disc 505 as shown. The electromagnetic coils in circuit 500 generate motor pulses 520 to push the magnets 502 in a circle. In operation, the pulse motor uses a transistor 515 coupled with oscillator circuitry (or a computer) to turn the electromagnetic coil 550 on and off which pushes the disc 505 which contains the magnets on the side. The electromagnet pushes the permanent magnets in the disc 505.

The pulse generator has little or no friction and therefore turns very fast. The pancake generator (FIG. 7) is connected either directly or indirectly. In an embodiment, the pancake generator is situated to sit on top of the pulse generator motor and is connected by a single shaft 530.

In the circuit, the pulse motor is attached to the pancake-shaped generator so as the solar pulse motor spins it spins the rotor which provides a rotating magnetic field that drives the rotating armature; the rotor is connect to the wheel of the pulse motor and takes advantage of the rotational energy of the solar pulse motor.

The stator of these devices may be either a permanent magnet or an electromagnet. Where the stator is an electromagnet, the coil which energizes it is known as the field coil or field winding. The coil can be either iron core or aluminum. To reduce loading losses in the device copper can be used as the conducting material in windings. Aluminum, because of its lower electrical conductivity, may be an alternate material. The device is able to produce power across multiple high-current power generation coils connected in parallel. Placing the field coils on the stator allows for an inexpensive mechanism to transfer high-voltage, low current power to the field coil.

In the case of Device 1 the magnet wire or enameled wire is wound tightly around an iron core andfashioned such that it is encompassed by the wheel cover. This armature takes up a large percentage of the wheel well or cover. This assembly constitutes the stator body housing. This armature winding is completely concealed by the wheel cover/well and is in the shape of the wheel cover. This dense magnet wiring cluster forms the first major segment of the Device 1 generator. There are several layers of wire in this cluster. The armature coil is stationary.

The rotor in comprised or permanent magnets which are incorporated in the wheel spokes. The armature coil assembly converts the mechanical energy of the rotating tire into electrical energy by passing the wheel through this armature winding. Said wheel, which houses the permanent magnets in the wheel spokes. The wheel thus becomes the rotor. The Rotor produces rotating magnetic flux or rotating magnetic field associated with the rotor inducing electricity in the armature coil attached to the wheel well or wheel cover.

Electrodes made of soft iron and permanent steel magnets spokes are arranged at intervals arounda center wheel hub. Each permanent magnet spoke is attached in sequence to the center hub. Eachmagnetic spoke is placed on the center hub alternating the north and south pole of each magnet. They are arranged in a pattern of four or more spokes and adhered on the wheel to form a tire. Thespokes are designed such that in addition to being permanent magnets they transmit the power from the hub to the rubber tube of the wheel.

FIG. 7 depicts a generator device 600 is a pancake shaped device that is responsive to pulses from the pulse generator to create charge.

In the window tinting sunscreen solar panel vehicle range extender and recharger of the embodiments herein the generator device 600 includes a wheel-based pancake shaped device housing 652 having a rotor 656 and a stator 653.

The rotor is the moving component of this electromagnetic system in this electric generator recharger range extender. Its rotation is due to the interaction between the windings and magneticfields which produces a torque around the rotor’s axis. This device can be characterized as an induction (asynchronous) generators recharger range extender because it has an electromagnetic system consisting of a stator and rotor. There are two designs for the rotor in this induction motor:squirrel cage and wound. In this generator recharger range extender, the rotor designs are salient pole or cylindrical.

The armature coil assembly converts the mechanical energy of the rotating tire into electrical energy by passing the wheel through the permanent magnet cluster. Said wheel, which houses thearmature coil on the wheel spokes. The wheel thus becomes the rotor. The Rotor produces rotatingmagnetic flux or rotating magnetic field associated with the rotor inducing electricity in the permanent magnet cluster attached to the wheel well or wheel cover.

Electrodes made of soft iron and tightly wired armature spokes are arranged at intervals around acenter wheel hub. Each armature spoke is attached in sequence to the center hub They are arrangedin a pattern of five or more spokes and adhered on the wheel to form a tire. The spokes are designedsuch that in addition to being wired armatures they transmit the power from the hub to the rubbertube of the wheel.

The stator is comprised of permanent magnets which are incorporated in the wheel well/cover. The stator assembly converts the mechanical energy of the rotating tire into electrical energy bypassing the armature coil spokes through the permanent magnet assembly. The magnetic wheelcover cluster is placed attached to the wheel well alternating the north and south pole of eachmagnet.

In one embodiment, the pancake rotor device 656 is connected to a vehicle wheel outer surface which houses the several permanent magnets situated in opposite pole position. An armature winding is wound around a concentrator core parallel to the permanent magnet rotor located in the wheel well cover (not shown). This design maximizes the charge generated and eases manufacturing and reliability of the device. This assembly constitutes the stator body housing 652. This armature winding is completely concealed by the wheel cover and is in the shape of the pancake. This dense magnet wiring cluster is the most efficient configuration for charge creation. There are several layers of wire in this cluster. The armature coil is stationary. The magnetic field is created through electric current in the wire-wound coil and strengthened by a soft-iron core. The armature coil assembly converts the mechanical energy of the rotating wheel magnets into electrical energy by passing the permanent magnets in close proximity to the armature winding. The pancake wheel device, which turn the permanent magnets thus becomes the rotor. The Rotor produces rotating magnetic flux or rotating magnetic field associated with the rotor inducing electricity in the armature coil attached to the device. The electricity produced is then diverted to a power strip.

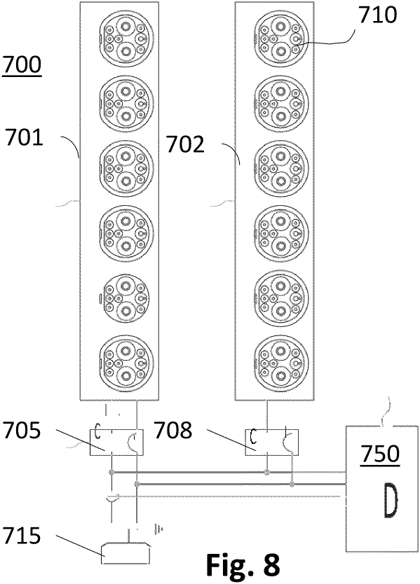

FIG. 8 depicts a smart power strip 700 which collects the power generated from all of the solar panels for subsequent diversion to the ultracapacitor for storage in an embodiment. Generally, the smart power strip 700 collects all of the various charge inputs and combines them into one usable format. This device allows the user to add charging accessories in addition to the range extender components. The user can add their own range extension devices such as but not limited to, solar roof panels, hydrogen fuel cells or fossil fuel-based range extenders. Like all power strips the SEVPS has a circuit breaker unit to prevent overload. In addition, the power strip bypasses the vehicle safeguards to allow for charging while driving. The charge is then passed to a smart Ultracapacitor Flash Storage Device (UFSD). The charge created by the GRE is so massive that it would be impossible to dump the charge into a standard battery pack as suggested by previous patents, therefore a buffer is used. The buffer in this device is a smart ultracapacitor pack. This device is configured to take fast or slow charging, high or low volume charging and then disseminate the exact charge needed to complete the user’s designated task, like powering the vehicle or powering an accessory. In an embodiment, before passing to the charge to the designated task it is moved through a Super Green Charge Computer (SGCC) 750. This charge computer hacks into the vehicle charging system to allow a foreign charge into the battery system. Once the task is complete or the day is finished the charge system allows for flash dumping of the excess charge to a desired source, like a mini grid or back to the grid. The GRE can even serve as its own micro grid to supply power to accessories or recreational vehicle appliances. The SGCC constantly monitors the entire charging system to ensure that there are no power surges, heat issues or power fluctuations.

The SEVPS includes a first input circuit 701 and second input circuit 702 each including receptacles 710 enabling six different inputs. First input circuit 701 operatively connects with an inverter circuit 705 and second inputs circuit 702 operatively connects with a rectifier circuit 708 and both circuits 705, 708 connect with the Ultracapacitor storage device 715 under control of the SGCC 750.

Using the SEVPS it is possible to create more charge than the vehicle could use on a daily basis which opens up the option of returning power to the grid on a daily basis. In doing so the SEVPS 700 negates the need for huge charging infrastructure expenditures. SEVPS 700 will eventually reduce the energy infrastructure demands and become a strategic power reserve. Moreover, the power returned to the grid will be done in areas of high vehicle concentrations which is where it will be needed most. The SEVPS can accept either AC or DC inputs and then sends the right charge to the right device. If power is needed to the engine or battery the SEVPS can send DC power. If the vehicle is equipped with AC power devices, then the SEVPS can send AC power to those devices. This innovation will make EV recreational vehicles a reality. The SEVPS can turn on and off any inputs when the maximum charge is achieved or more charge is needed. This device allows the GRE to charge the battery while the vehicle is in motion. This universal device can take charge from any number of unlimited sources.

In a further embodiment, the smart EV power strip 700 allows EV owners to use their vehicles in any country or jurisdictions easily by accepting all inputs. Smart EV Power Strip (SEVPS) and consists of a rectifier and an inverter. Thus, allowing the device to handle both AC and DC charge inputs and outputs. The various six receptacle inputs that can be used on the power strips to accept universal charges from around the world.

In a further embodiment, the configuration shown in FIG. 7 of a single two-sided pancake-shaped rotor and two pancake-shaped stators (also referred to as an Axial Flow Device (AFD)) maximizes the rotational energy of the motor shaft. The rotor is placed at the center of the two stators in parallel. The three-pancake disc are appropriately space to achieve the optimal gap. As the shaft is rotated the AFD spins the rotor in the presence of the two stationary stator pancake device which creates charge. This charge is then diverted to SEVPS, then the UFSD and then the SGCC.

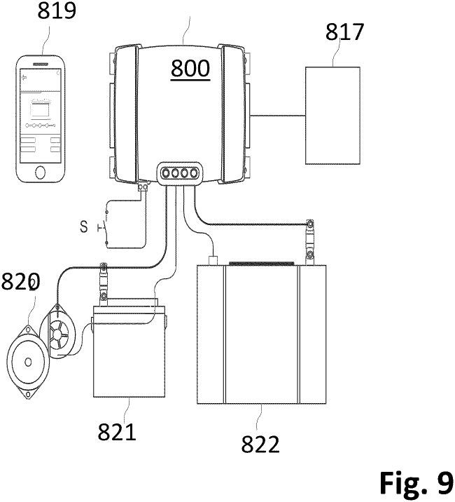

FIG. 9 is a block diagram of a charge computer 800 for use in window tinting sunscreen solar panel vehicle range extender and recharger of an embodiment. In the embodiment, the charge computer is a smart charge computer controller that receives the power from the solar pulse generator and sends the power to the vehicle, a building or a storage device. Charge computer device 800 connects with, an electric grid micro grid 817, the electrical vehicle 820, auxiliary battery 821 and a battery pack 822 and is controllable via a wireless connection from a cell phone device 819.

The SGCC 800 controls the volume of charge, type of charge, the volume of output and where the charge is going. This device also bypasses the system that stops the EV from charging while driving. This device will automatically make the outgoing charges compatible with the vehicle or accessory that is targeted. The SGCC can allow a unidirectional or bidirectional power flow at all power levels. The bidirectional power flow adds to the grid-to-vehicle interaction (G2V) also the vehicle-to-grid (V2G) mode. This latter technology can bring significant improvement in the overall reliability of the distribution grid, since in case of system failure, peak load demand or other unexpected scenarios, with a bidirectional power flow, the EVs can be used as back up generation, supplying the energy back to the grid when needed. With V2G, as all the energy storage systems, EVs battery can be used not only as back up resource but also to improve the power quality, the stability, and the operating cost of distribution network. Moreover, in the long run, V2G could reduce investment in new power generation infrastructure.

In an embodiment, the power from the solar pulse generator of the attached window tinting sunscreen solar panel vehicle range extender and recharger is directed to the smart green computer controller (SGCC) that sends the power to the vehicle, or alternatively, a building, an energy storage device or a micro grid where it can be collected with other energy devices for use or sent back to the grid.

The solar panel-based generator of a range extender and recharger for an electric vehicle further includes a solar panel which convers solar energy into electricity, then uses that electricity to power a pulse motor which powers a pancake generator. This is a high efficiency, brushless generator design that utilizes the solar energy from solar panels, together with the mechanical energy of the pulse motor to create a brushless generator that will deliver power to the engine directly or can be diverted to the battery bank for recharging. This device can be configured several ways. The primary way to configure this device is denoted in this application as Device 1. In the case of Device 1 the pulse generator is arranged such that this pulsed motor uses short pulses of current to drive the motor, making it spin which is powered by the solar panels. The spinning rotor of the pulse motor is heavy, acting as a flywheel, and has multiple permanent magnets spaced equally around its periphery. These magnets are usually extremely strong and can be arranged in a variety of different configurations. In device 1 all the magnets facing radially outward.

The stator is the stationary part of the motor that surrounds the rotor. It holds one or more electrical coils. They are positioned so that the magnets line up with the coils during part of the rotation. The coils are energized when they are exactly lined up with the permanent magnets in the rotor. This requires very precise timing, usually achieved through some type of electronic control circuit.

The electrical coils are normally wound so that, when energized with a short pulse of current, they produce a repulsive force. This repulses the magnet in the rotor, causing it to rotate. Controller power circuits that produce the rotational torque by delivering pulses to the electrical coils at a precise moment during the rotation of the motor.

The pulse motor is attached to a pancake generator. This assembly constitutes the stator body housing and has electrodes made of soft iron. This armature winding is completely concealed by the housing in the shape of a pancake. This dense magnet wiring cluster forms the firstmajor segment of the Device 1 generator. There are several layers of wire in this cluster. The armature coil is stationary. The magnetic field is created through electric current in the wire-wound coil and strengthened by a soft-iron core. The armature coil assembly converts the mechanical energy of the rotating pulse motor into electrical energy by passing the permanent magnet in the housing rotors through this armature winding. The generator housing, which houses the permanent magnets on the rotor wheel. The wheel thus becomes the rotor. The Rotor produces rotating magnetic flux or rotating magnetic field associated with the rotor inducing electricity in the armature coil attached to the housing. The electricity produced is then diverted to the charge controller. The charge controller now powers the engine directly or recharges the battery based on the currentneeds of the vehicle. Permanent magnetics are arranged at intervals around a center wheel hub. Each permanent magnet is attached in sequence to the center hub. Each magnet is adhered to the center hub alternating the north and south pole orientation of each magnet. They are arranged in a pattern of four or more and adhered to the wheel to form the device.

The range extender device can be used to power automobiles where the solar panels are placed on the roof of the vehicle or in the windows. The power produced by these devices will be sufficient to power the frictionless low torque high speed pulse motor (FIG. 6). The super high speeds of the pulse motor can be used to power the rotor of the pancake generator (FIG. 7) and create high voltage. This device can also be used to power buildings and homes by using solar panels or wind turbines and diverting this energy to the ultracapacitor storage device which will be used to power the pulse motor. Placed in a side car-based system or mounted in a building this high speed portable charging system which is essentially a mobile commercial generator that uses the same principle of converting the mechanical energy of the pulse generator into electricity. The idea is that this charge on the go system will negate the need for lengthy charging stops for vehicles and allow buildings to become truly green.

In order to gain exponential range extension, provide more power for greater horsepower, a platform is created that will have immediate and long-term environmental benefits while simultaneously reducing charging times, improving EV overall efficiency, the present invention adopts followingtechnical scheme:

A kind of solar powered electric vehicle recharging system that greatly extends the range of any vehicle, greatly reduces or eliminates the need for fossil fuel based recharging and electric grids,

Beneficial effect of the present invention is as follows:
(1), system increases the range of an electric vehicle up to 400%;
(2) compared with traditional range extenders this device requires no additional fuels;
(3), compared with traditional solar panel -based generators this device has much greater charging capacity and reliability;
(4), compared with other types of pulse generator motors based recharging systems which rely heavily on back EMF recapture, this system has more reliability and predictability;
(5) can be very applicable and installed on all existing Electric Vehicles;
(6) compared to other range extenders this device lowers the sprung weight of the vehicle;
(7) compared to other range extenders this device has zero emissions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. An electric vehicle generator range extending charging system comprising;
a solar pulse motor device for generating electrical energy pulses;
one or more retractable solar panels mounted on or within a vehicle, each mounted retractable solar panel configured to collect sunlight and convert energy from the sunlight into electricity;
a smart power strip that collects and combines the electricity from all of the mounted retractable/translucent solar panels;
a smart ultracapacitor configured to receive the combined electricity to power the solar pulse motor,
a pancake shaped generator device that contains both a rotor and a stator and is attached to the solar pulse motor,
a smart charge controller that receives the energy from the solar pulse motor device and then directs that energy to power another device.

2. The vehicle generator range extending system of claim 1, wherein the smart charge controller that receives the energy from the solar pulse motor device directs that energy to an energy storage device.

3. The vehicle generator range extending system of claim 1, wherein the smart charge controller that receives the energy from the solar pulse motor device directs that energy to an micro grid storage device, wherein the micro grid storage device used to take the excess charge from all devices and any external devices used by the vehicle owner and stores this energy, uses the energy for multiple applications or redirects the energy to a grid.

4. The vehicle generator range extending system of claim 1, wherein the retractable solar panel is translucent.

5. The vehicle generator range extending system of claim 1, wherein the solar pulse motor powers the pancake shaped generator device at a high rotational speed.

6. The vehicle generator range extending system of claim 5, wherein the pancake shaped generator device comprises: bonded magnetic conductive soft iron and permanent magnet elements spaced apart at the pancake rotor, a magnetic conductive soft iron and a set of permanent magnets pole in a pair.

7. The vehicle generator range extending system of claim 6, wherein the pancake shaped generator device comprises a stator wheel casing fixed on a housing body panel, and a the pulse motor having a rotating axle, the rotating axle rotating the rotor around stator core wheel thereby inducing electricity.
